(19) United States
(12) Patent Application Publication
(10) Pub. No.: US 2004/0252588 A1
(43) Pub. Date: Dec. 16, 2004

(54) Liquid ornament with a timekeeping device

(76) Inventor: Vincent K. Lee, Taipei (TW)

Correspondence Address: DENNISION, SCHULTZ, DOUGHERTY & MACDONALD, 1727 KING STREET, SUITE 105, ALEXANDRIA, VA, 22314, US

(21) Appl. No.: 10/748,132

(22) Filed: Dec. 31, 2003

(30) Foreign Application Priority Data
Jun. 11, 2003 (TW) 092210671

(51) Int. Cl. G04B 19/26

(52) U.S. Cl. 368/19

(57) ABSTRACT

A liquid ornament with time-related device, is basically formed by combining a time-related main body and a main casing. The shape of the main casing can be like the traditional shape of a tumbler (an easily tipped toy that quickly rights itself). The main casing at least comprises a secondary casing and a liquid ornamental casing. The liquid ornamental casing can be mounted on the top of the secondary casing, mounted below the bottom of the secondary casing, or at an appropriate position on the secondary casing. The main purpose of the present invention is to let the time-related device with liquid ornament shake like a tumbler, so that the liquid and the decorative structure inside the liquid ornamental casing can perform a rocking effect.

### BACKGROUND OF THE INVENTION

1. Field of the Invention

The present invention relates to a liquid ornament with a timekeeping device, where the timekeeper can be a clock, an alarm, a stopwatch, a timer, etc.

2. Description of the Related Art

A combination clock and liquid ornament can be found in U.S. Pat. No. 5,272,681, and U.S. Pat. No. 5,159,583. The clock is adorned with the liquid ornament. The liquid ornament comprises at least one type of liquid (usually two types of liquid with different colors and different specific weights), and at least one float.

However, the prior art does not provide a rocking clock that shows the liquid when the liquid ornament is rocking.

Therefore, it is desirable to provide a liquid ornament with a timekeeping device to mitigate and/or obviate the aforementioned problems.

### SUMMARY OF THE INVENTION

A main objective of the present invention is to provide a liquid ornament with a timekeeping device which is more interesting and fun.

Another objective of the present invention is to provide a liquid ornament with a timekeeping device which can rock so that the liquid shakes and a float in the liquid rocks as well.

In order to achieve the above-mentioned objectives, the present invention combines a timekeeper body and a main casing. A shape of the main casing can be like the traditional shape of a tumbler (an easily tipped toy that quickly rights itself), which means a lower part of the main casing is larger than the upper part of the main casing, like an egg. The main casing at least comprises a secondary casing and a liquid ornamental casing. The liquid ornamental casing can be mounted on the top of the secondary casing, mounted below the bottom of the secondary casing, or at an appropriate position on the secondary casing. In order to make the liquid ornament with a timekeeping device of the present invention rock, a weight may need to be utilized.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a first embodiment according to the present invention.

FIG. 2 is a schematic drawing of a second embodiment according to the present invention.

FIG. 3 is a schematic drawing of a third embodiment according to the present invention.

FIG. 4 is a schematic drawing of a fourth embodiment according to the present invention.

FIG. 5 is a schematic drawing of a fifth embodiment according to the present invention.

### DETAILED DESCRIPTION OF THE PREFERRED EMBODIMENT

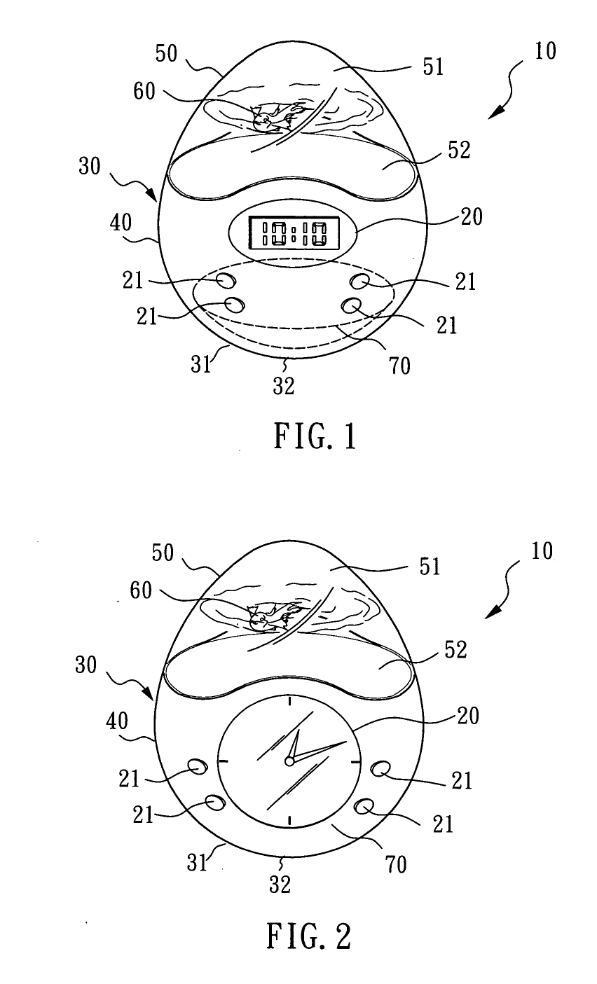

Please refer to FIG. 1. FIG. 1 is a schematic drawing of a first embodiment according to the present invention. A liquid ornament with a timekeeping device 10 of the present invention combines a timekeeper body 20 and a main casing 30, and further comprises buttons 21 (or switches) for operational purposes. The timekeeper can be a clock, an alarm, a stopwatch, a timer etc. In this embodiment, a clock is used by way of example. Since the present invention does not involve improvements to the timekeeper body 20, no additional detail about the timekeeper body 20 is provided. In the drawings, in order to simplify the appearance of the liquid ornament with a timekeeping device 10, only a display device of the timekeeper body 20 is shown, and the other parts are disposed inside the main casing 30.

The main casing 30 has a bottom 31, and the bottom 31 has a smooth curved surface 32. A shape of the entire main casing 30 is like that of a traditional “tumbler” (an easily tipped toy that quickly rights itself), which means that a lower portion of the main casing is larger than the upper portion of the main casing, like an egg. The main casing 30 at least comprises a secondary casing 40 and a liquid ornament casing 50. In this embodiment, the liquid ornament casing 50 is located above the secondary casing 40, and the timekeeper body 20 is combined with the secondary casing 40 of the main casing 30. Furthermore, the secondary casing 40 further comprises a weight 70 at its bottom, so the liquid ornament with a timekeeper device 10 rocks but does not topple. However, depending upon a weight distribution, the weight 70 may not be necessary; for example, when the timekeeper body 20 and a battery (not shown) are disposed at a lower position.

The liquid ornament casing 50 is a sealed casing, and the liquid ornament casing 50 comprises at least a liquid and at least one float 60. In this embodiment, the liquid ornament casing 50 has a first liquid 51, a second liquid 52 and one float 60 inside. A specific weight of the first liquid 51 is lighter than a specific weight of the second liquid 52. The two liquids 51, 52 usually have two different colors, and the float 60 floats between the first liquid 51 and the second liquid 52.

Please refer to FIG. 2. FIG. 2 is a schematic drawing of a second embodiment according to the present invention. The difference between the second embodiment and the first embodiment is that the timekeeper body 20 (clock) uses a mechanism that has additional weight, and so the weight 70 can be omitted.

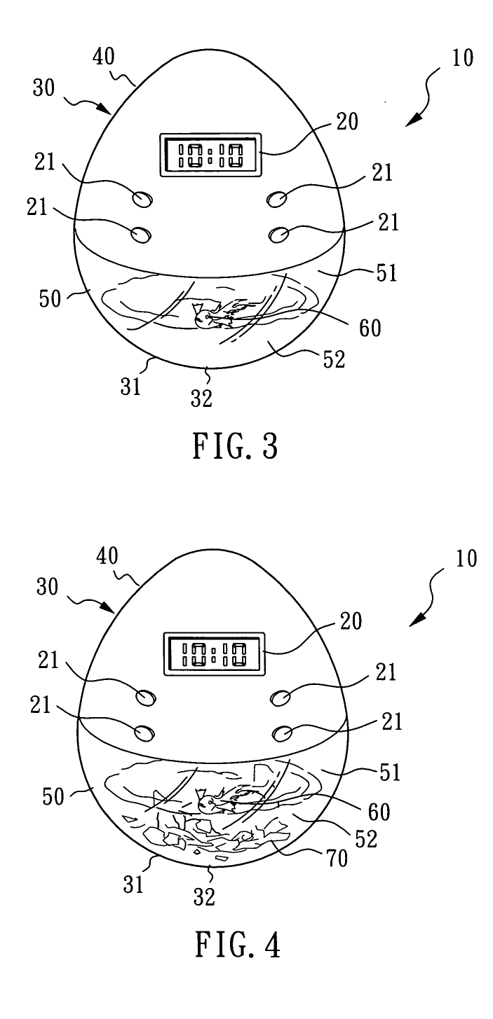

Please refer to FIG. 3. FIG. 3 is a schematic drawing of a third embodiment according to the present invention. The difference between the third embodiment and the first embodiment is that the liquid ornament casing 50 is located below the secondary casing 40, and since the liquid ornament casing 50, the first liquid 51 and the second liquid 52 are sufficiently heavy so that there is no need for the weight 70.

Please refer to FIG. 4. FIG. 4 is a schematic drawing of a fourth embodiment according to the present invention. The fourth embodiment is basically the third embodiment with the weight 70. The weight 70 can be shaped to match the shape of the float 60, and may be adhered to the bottom of the liquid ornament casing 50.

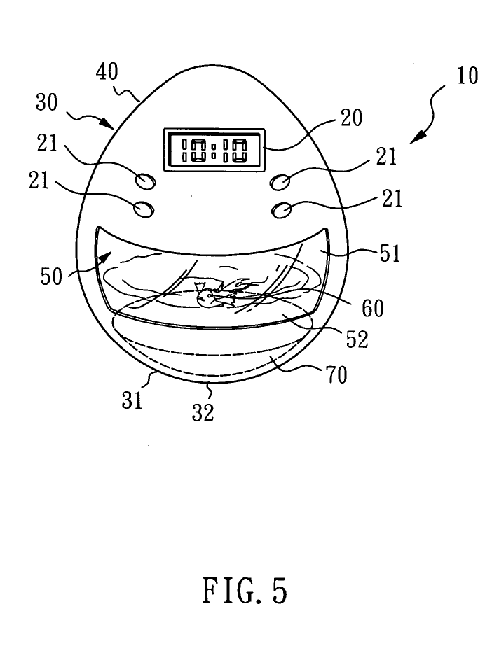

Please refer to FIG. 5. FIG. 5 is a schematic drawing of a fifth embodiment according to the present invention. The liquid ornament casing 50 in this embodiment is not located below or above the secondary casing 40, but instead at an appropriate position on the secondary casing 40, and the weight 70 is located at the bottom of the secondary casing 40.

Although the present invention has been explained in relation to its preferred embodiment, it is to be understood that many other possible modifications and variations can be made without departing from the spirit and scope of the invention as hereinafter claimed.

What is claimed is:

1. A liquid ornament with a timekeeping device comprising:
a timekeeper body; and
a main casing, wherein:
the main casing has a bottom and the bottom has a smooth curved surface;
the main casing has a secondary casing and a liquid ornament casing, the liquid ornament casing being a sealed casing, and the liquid ornament casing comprises at least a liquid and at least one float;
the main casing and the timekeeper body combined together to form the liquid ornament with the timekeeping device, and a center of gravity located at a lower part of the liquid ornament with the timekeeping device, whereby the liquid and the decorative structure inside the liquid ornamental casing performs a rocking effect.

2. The liquid ornament with a timekeeping device as claimed in claim 1, wherein the timekeeper body is combined with the secondary casing of the main casing.

3. The liquid ornament with a timekeeping device as claimed in claim 1, wherein the secondary casing is located below the liquid ornament casing.

4. The liquid ornament with a timekeeping device as claimed in claim 1, wherein the secondary casing is located above the liquid ornament casing.

5. The liquid ornament with a timekeeping device as claimed in claim 1, wherein the bottom of the main casing further comprises a weight.

6. The liquid ornament with a timekeeper device as claimed in claim 3, wherein the liquid ornament casing further comprises at least one float.

7. The liquid ornament with a timekeeper device as claimed in claim 3, wherein the bottom of the main casing further comprises a weight.

8. The liquid ornament with a timekeeper device as claimed in claim 4, wherein the bottom of the main casing further comprises a weight.
